(19) United States
(12) Patent Application Publication
(10) Pub. No.: US 2007/0129980 A1
(43) Pub. Date: Jun. 7, 2007

(54) Transactional atomicity in service interactions of business processes

(76) Inventor: Alistair P. Barros, Camira (AU)

Correspondence Address: Brake Hughes PLC;c/o PortfolioIP, P.O. Box 52050, Minneapolis, MN, 55402, US

(21) Appl. No.: 11/292,866

(22) Filed: Dec. 2, 2005

(51) Int. Cl. G06F 9/46

(52) U.S. Cl. 705/8

(57) ABSTRACT

Various implementations are disclosed for enabling transactions in which a reply constraint(s) is defined between a minimum and maximum number of a defined group of recipients that are requested to respond to a sender within a defined time limit. Further, a determination of whether the reply constraint is satisfied is made during a first phase of a two-phase transaction, in which the first phase represents an abbreviated version of the desired transaction, and is used to ensure fulfillment of the reply constraint before the fill transaction is allowed to proceed. In this way, flexibility may be obtained in executing an atomic multicast transaction, while a determination of a likely success of the transaction (as well as the resulting execution of the transaction) may be performed quickly, reliably, and efficiently.

### TECHNICAL FIELD

This description relates to service interactions.

### BACKGROUND

Modeling languages may be used as meta-languages to describe and execute underlying processes, such as business processes. For example, process modeling languages allow an enterprise to describe tasks of a process, and to automate performance of those tasks in a desired order to achieve a desired result. For instance, the enterprise may implement a number of business software applications, and process modeling may allow coordination of functionalities of these applications, including communications (e.g., messages) between the applications, to achieve a desired result. Further, such process modeling generally relies on language that is common to, and/or interoperable with, many types of software applications and/or development platforms. As a result, process modeling may be used to provide integration of business applications both within and across enterprise organizations.

Some business processes include at least one task that requires interactions between a sender and an atomic group of recipients. Further, success of such a task, and, therefore, of the business process as a whole, may rely on interdependencies between actions of the recipients. For example, if the task includes the sender soliciting bids from the group of recipients as part of an auction, a successful bid of one recipient may be dependent on the other bids being lower.

Accordingly, in some situations, the business process may require that all of the group of recipients participate in the interactions, so that if one or more recipients does not participate within a defined time limit, then the overall transaction may be cancelled. For example, booking travel reservations that include a plurality of connecting flights may require either that reservations for all legs of the journey be made, or that none be made, so as to avoid providing the traveler with an incomplete itinerary.

### SUMMARY

According to one general aspect, availability requests are sent to a group of recipients according to an instance of a process model to determine available recipients for implementing a transaction of the process model, based on responses to the availability requests. The responses are evaluated to determine satisfaction of a reply constraint governing a required number of the available recipients. A service request is sent to accepted recipients of the available recipients, to implement the transaction.

According to another general aspect, a message formatting system is operable to format availability requests for a group of recipients associated with an instance of a process model. An orchestration engine is operable to execute the process model including sending the availability requests to the recipients, and evaluating responses received from the recipients within a defined time-out period to determine available recipients for implementing a transaction of the process model.

According to another general aspect, a computer program product includes a signal-bearing medium bearing at least one of one or more instructions for providing availability requests for a group of recipients associated with an instance of a process model, one or more instructions for evaluating responses received from the recipients to determine available recipients for implementing a transaction of the process model, based on a reply constraint specifying a minimum number of available recipients required to complete a transaction associated with the process model, and one or more instructions for sending a service request to accepted recipients of the available recipients, for execution thereby of the transaction.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for performing atomic multicast transactions.

FIG. 2 is a flowchart illustrating an operation of the system of FIG. 1.

FIG. 3 is a flowchart illustrating a further operation of the system of FIG. 1.

FIG. 4 is a flowchart illustrating a further operation of the system of FIG. 1.

FIG. 5 is an example message that may be used in the system of FIG. 1.

FIG. 6 is an example message that may be used in the system of FIG. 1.

FIG. 7 is an example message that may be used in the system of FIG. 1.

FIG. 8 is an example message that may be used in the system of FIG. 1.

FIG. 9 is an example message that may be used in the system of FIG. 1.

FIG. 10 is a block diagram of an alternative implementation of the system of FIG. 1 using nested transactions.

FIG. 11 is a flowchart illustrating an operation of the system of FIG. 10.

### DETAILED DESCRIPTION

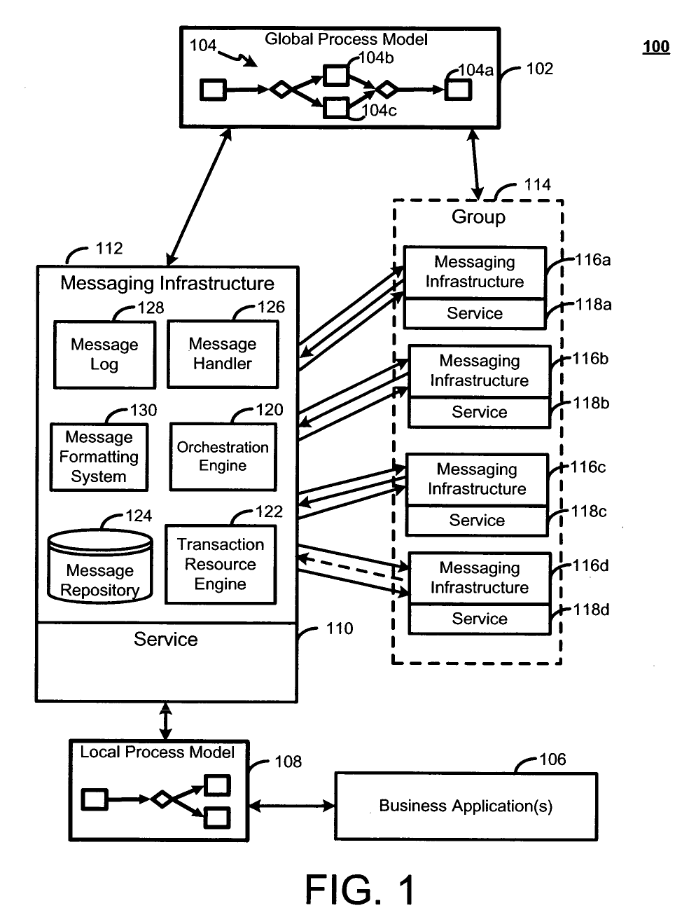

FIG. 1 is a block diagram of a system 100 for performing atomic multicast transactions. The system 100 enables transactions in which a reply constraint(s) is defined between a minimum and maximum number of a defined group of recipients that are requested to respond to a sender within a defined time limit. Further, a determination of whether the reply constraint is satisfied is made during a first phase of a two-phase transaction, in which the first phase represents an abbreviated version of the desired transaction, and is used to ensure fulfillment of the reply constraint before the full transaction is allowed to proceed. In this way, flexibility may be obtained in executing an atomic multicast transaction, while a determination of a likely success of the transaction (as well as the resulting execution of the transaction) may be performed quickly, reliably, and efficiently.

Thus, in the example of FIG. 1, a global process model 102 represents a business process model that is implemented, and agreed on, by a number of collaborating service providers, such that the service providers perform tasks 104 of the global process model 102. In the following description, examples are given in which at least one of the service providers takes the role of sending a request for information or functionality (and thus may be referred to as a sender) to a group of receiving service providers (which may be referred to as recipients). Of course, it should be understood that this nomenclature merely reflects the fact that the sending service provider (sender) initiates the transactions and thereby obtains desired information/functionality from one or more of the receiving providers (recipients). However, it should be understood that the sender may, at various points later in a message interaction(s), receive one or more messages, while the recipient(s) similarly, at times, may send a message. Examples of such messaging interactions are described in detail, below.

The service providers may make pre-arrangements regarding their interactions with one another (e.g., arrangements governing messages, message formats, or message types, as well as arrangements governing an order of the messages to be sent and/or tasks to be performed). By way of specific example, a purchase order may be sent by one service provider (the sender) that may require either acknowledgement or rejection by one or more other service provider(s) (the recipient(s)). As another example of a rule enforced by the global process model 102, two sequential requests of any sort may be disallowed. The global process model 102 (also referred to as a global choreography model) thus provides a way of capturing, contractualizing, and implementing potentially complex and long-running message exchange sequences between service providers, in order to execute a desired business process.

For example, a business application 106 may be built and implemented by an enterprise or other entity to perform some business functionality, such as, for example, creating a purchase order and sending the purchase order to a number of (possibly competing) suppliers. The business application 106 may implement a local process model 108 that, analogously to the global process model 102, formalizes and defines the roles of the business application 106 within the global process model 102, e.g., with respect to the purchase order example just mentioned. For example, the local process model 108 may describe what types of messages may or should be exchanged with the suppliers as part of the purchase order.

The local process model 108 attempts to capture as many as possible of the potential variations or implementations of the business application 106 (e.g., a purchase order application). Such variations or implementations may, for example, include recipient-dependent message types, or may require a certain order of messages to be exchanged with recipients (e.g., suppliers). Thus, depending on a particular, current use of the business application, the local process model 108 may be copied and configured to form different process model instances. For example, if a user (not shown in FIG. 1) accesses the business application 106 and enters a first type of purchase order designated to be sent to a first group of recipients, then a different instance of the local process model 108 will be configured as compared to another user who selects a second type of purchase order that is to be sent to the same or different recipients (suppliers).

In the example of FIG. 1, tasks of the global process model 102 and the local process model 108 are executed at least in part using application services. For example, the business application 106 and the local process model 108 may be associated with at least one service 110. In this context, the service 110 refers to an application having one or more specific functionalities that are exposed to other applications, often over a network (e.g., the Internet) by way of a service interface (where an operation and use of the interface may be known or determined, as needed). When such a service (and/or an interface of the service) is exposed/available over the World Wide Web (referred to herein as the WWW or the web), then the service may be known as a web service.

Using such services and service interactions to implement process models may be referred to as a service-oriented architecture (SOA), in which, as just described, process tasks result in execution of the services. Further, processes that rely on services to realize process steps may themselves be deployed and accessed as services, which may be referred to as process-based service composition. Languages exist, such as, for example, the Business Process Execution Language (BPEL), that are designed to provide such compositions of services (e.g., web services), and thus provide a top-down, process-oriented approach to the SOA. Accordingly, BPEL or other such languages (such as, for example, the Web Services Flow Language (WSFL), the language (XLANG), and/or the Business Process Modeling Language (BPML)), or modifications/extensions thereof, may be used to define the global process model 102 and/or the local process model 108.

In FIG. 1, in order to integrate the service 110 within the global process model 102, a messaging infrastructure 112 is included. Generally, the messaging infrastructure 112 facilitates instantiation and execution of the local process model 108 in a way that allows atomic multicast transactions with a group 114, where the group 114 includes a plurality of recipient services 116a-116d, each with their own respective messaging infrastructures 118a-118d.

The messaging infrastructure 112 includes an orchestration engine 120 that is operable, among other functions, to execute an instance of the local process model 108. For example, the orchestration engine 120 may be in charge of ensuring that a given task of the local process model 108 has actually been executed and completed, before allowing the instance to proceed to a following task. Other functions and examples of the orchestration engine 120 are described in more detail, below.

A transaction resource engine 122 provides transactional support to the orchestration engine 120. That is, the transaction resource engine 122, for example, works to ensure that transactions between the (sender) service 110 and the (recipient) services 118a-d are maintained as part of the configured and instantiated version of the local process model 108, and that messages from/to the service 110 and the services 118a-d are matched and correlated with one another, and with the services 110 and 118a-d. For example, system and/or transaction identifiers may be included in, and/or added to, messages between the services 110 and 118a-d, as well as date/time stamps. Additionally, such transactional support may be included in message control data (e.g., a header) for each message.

A message repository 124 represents a database or other memory that may be used, for example, to store message types or templates, as well as actual messages (including both outgoing and/or incoming messages). For example, as described in more detail below, the message repository 124 may include a number of message types that are specific to, or associated with, (functionality of) the business application 106. For instance, in the case where the business application 106 is used to generate purchase orders, there may be a number of associated message types in the message repository 124, which may be pre-configured to some extent based on, for example, a type of purchase order or an identity of the recipient(s) of the purchase order.

In this way, for example, message types (or related information, e.g., messaging parameters or message control data) may be selected and associated with a particular instantiation of the local process model 108, in order to configure the instantiation in a desired manner. For example, a “send” operation associated with a message sent as part of the particular instantiation of the local process model 108 may be configured to have a certain characteristic, such as a “guaranteed send” that is required to receive an acknowledgement from an intended recipient of the message.

A message handler 126 may be used to send and receive actual messages of the messaging infrastructure 112 during communications with the recipient services 118a. For example, in a case where the orchestration engine 120 is executing a plurality of instances of the local process model 108, the message handler 126 may be responsible for sending messages of the various instances to the appropriate recipients, using appropriate transmission techniques and/or protocols. Conversely, for incoming messages, the message handler 126 may be used to sort and/or route messages to appropriate portions of the messaging infrastructure 112, the sender service 110, and/or the business application 106. The message handler 126 also may serve as a buffer or queue for incoming and outgoing messages.

In the latter regard, for example, the message handler 126 may serve as a queue for incoming messages, which may ultimately be forwarded to a message log 128. The message log 128 may be used to track each incoming (and outgoing) message(s), and, ultimately, persist the messages to the message repository 124. For example, for an incoming message, the transaction resource engine 122 may be used to analyze a message header or other message control data and thereby to track a identifier of the process instance, a date/time stamp, or other identifier (e.g., an identifier assigned by one of the recipient messaging infrastructures 116a-116d). Then, as described in more detail below, the message log 128 may thus be enabled to store the incoming logged message(s) with corresponding message(s) that were initially sent by the sender service 110. Thus, the messaging infrastructure 112 is able to recognize a transactional nature of communications between the services 110 and 118a-118d.

Finally in FIG. 1, a message formatting system 130 may be used, for example, to prepare a message for sending by the orchestration engine 120 and the message handler 126. For example, the message formatting system 130 may be used to format a desired message against a message type specified as part of the configuration of the local process model 108. Further, the message formatting system 130 may be used to support the atomic multi-cast transactions referenced above, which may utilize a two-phase procedure for interactions between the service 110 and the services 118a-d of the group 114, in which the two-phase procedure is subject to a reply constraint(s) governing involvement (or non-involvement) of the recipient services 118a-d.

In particular, for example, the message formatting system 130 may be used to filter (prior to sending) a message of the local process model 108, to obtain a filtered message. Then, the filtered message may be sent to the group 114 of the recipient services 118a-d as part of the first phase of the two-phase procedure just referenced. For example, the message may be filtered such that the resulting filtered message contains sufficient information to notify the recipient services 118a-d of which of their functionality is being requested by the sender service 110, without including sufficient information to actually allow the recipient services 118a-d to proceed with providing such functionality.

In this way, the messaging infrastructure 112 may make a determination during the first phase of the two-phase procedure as to whether and how many (e.g., with respect to the reply constraints referenced above) of the recipient services 118a-d are capable of providing the desired functionality. Thus, at least a minimum number, but no more than a maximum number, of the recipient services 118a-d, will be assured of actually participating in the desired interaction with the sender service 110, where the minimum and/or maximum numbers are defined in the reply constraints. Moreover, the determination of which of the recipient services 118a-d will participate in the interaction may be made in a timely fashion (e.g., subject to a time-out requirement). Accordingly, business processes that may involve a few to hundreds of entities, and that may span moments, days, or weeks, may be managed in an efficient and reliable manner.

Thus, in operation, a user of the business application 106 may wish to send out a purchase order to the group 114 of the recipient services 118a-d. Therefore, the user may access a user interface (not shown) of the business application 106, and may enter four line items specifying the four specific recipient services 118a-d, along with any other desired data/parameters, such as a type of the purchase order request. Then, the business application 106 may configure the local process model 108 accordingly, so as to implement an instance of the local process model 108 that is particular to the user's desired scenario.

Techniques and examples of such configuration of the local process model 108 are described in more detail below. Generally, however, it may be understood that such configuration may depend on, and be regulated by, features and functionalities of the messaging infrastructure 112. For example, the business application 106 may configure the local process model 108 to implement a certain message type, based on message types available in the message repository 124. Similarly, the orchestration engine 120 may be involved at least indirectly in the configuration and/or instantiation of the local process model 108, since it is the orchestration engine 120 that ultimately is intended to execute the resulting local process model instance.

Further, the message formatting system 130 may be used to configure the message types selected from the message repository with message control data that is specific to, and appropriate for, the instance of the local process model 108. For example, message control data may include a designation of application data to be used as a message identifier (e.g., a purchase order number, or invoice number, or, in another setting, a reservation number), where the application data is selected due to its known or presumed uniqueness. As such, such a message identifier may be used to correlate related messages, e.g., during the two-phase interaction procedure referenced above. In other implementations, unique identifiers may be generated by the message formatting system 130 and/or the transaction resource engine 122 for the message control data, without a direct dependence on any particular application data.

The result of the above-described configuration of the local process model 108, in pertinent part, is that the orchestration engine 120 becomes able to execute an instance of the local process model 108, according to the two-phase interaction procedure referenced above. In this regard, it should be understood that the message(s) to be generated based on the message repository 124 and the message formatting system 130 initially represent “full” messages that include sufficient information to allow any one of the recipient services 118a-d to proceed with providing a requested functionality.

As a result, sending such a full message to the recipient services 118a-d may result in all (or an unpredictable or difficult-to-determine number) of the recipient services 118a-d actually commencing with the actions requested in the message. Although perhaps acceptable in some situations, it is also true that, as referenced above, in situations where there is some inter-dependence on or between actions of the recipient services 118a-d (e.g., when the recipient services 118a-d are submitting competing bids or reserving multiple legs of a traveler's itinerary), it may not be desirable simply to have the recipient services 118a-d proceed independently in such an unregulated manner. For example, allowing the recipient services 118a-d to proceed in this manner may result in a need to “roll-back” or undo actions of one of the recipient services 118a-d, when it is later determined that another one of the recipient services 118a-d is better-suited to performing the task in question.

Accordingly, the message formatting system 130 may filter the full message and obtain a filtered message that contains enough information to allow the recipient services 118a-d to determine whether, if asked, they could provide the requested functionality, but does not provide enough information to allow the recipient services 118a-d to proceed with providing the requested functionality. In other words, the filtered message serve as an example of an availability request that may be sent to the recipients 118a-118d to specify an availability of each recipient with regard to providing a service (e.g., implementing a transaction of the process model). For example, in an airline booking scenario, the filtered message (i.e., availability request) may specify a source and destination of a flight, and a time of travel, but may not provide the traveler's name or credit card information. As such, where the recipient services 118a-d are travel reservation services, each of the recipient services 118a-d may determine whether it is possible to book such a reservation, yet none of the recipient services 118a-d will actually (be able to) do so.

The configured local process model provides, or allows for the determination of, associated information regarding the members of the group 114, the minimum and maximum reply constraints, and required time-out information. For example, the user may specify some or all of this information through the business application 106. As another example, the user may simply specify the recipient services 118a-d, and the business application 106 and/or the messaging infrastructure 112 may determine the reply constraints and/or time-out period, based on the user-input data and/or on determinable parameters (e.g., the message type or the interaction type).

Once the filtered message and the reply constraints/time-out are available, the orchestration engine 120 may proceed with executing the relevant portion of the local process model 108 (and of the global process model 102) by sending out the filtered message to all of the recipient services 118a-d as part of a first phase of the two-phase interaction process. As described, the filtered message may be sent with one or more identifiers (provided by the message formatting system 130 and/or the transaction resource engine 122) and with a date/time stamp provided by the transaction resource engine 122.

Then, any of the recipient services 118a-d receiving the filtered message may acknowledge receipt thereof with a response (e.g., return message), but without commencing the specified functionality. The responses may contain additional identifier(s) added by the particular recipient service 118a-d, so that the message log 128 and/or the transaction resource engine 122 may determine that the responses are part of the same transaction as the originally-sent message, but that the response(s) is/are specific/unique to each of the recipient services 118a-d.

During the specified time-out period, the message handler 126 and the message log 128, possibly together with transaction support provided by the transaction resource engine 122, may analyze the message control data of each incoming message, associate each incoming message with an earlier-sent outgoing message, and log the response in the message log 128, with as status either as “available/accepted” or “rejected” (while persisting the response itself to the message repository 124). Then, once the time-out period has expired, the orchestration engine 120 may determine whether the minimum and/or maximum reply constraint(s) have been satisfied (e.g., by counting against the responses logged in the message log 128, using the included status information, as just described). Accordingly, a judgment may be made as to whether a sufficient or acceptable number of recipients have indicated availability for implementing a desired transaction of the process model.

Subsequently, and assuming for this example that a sufficient/acceptable number of recipients was, in fact, determined, the orchestration engine 120 may proceed with executing the second phase of the two-phase interaction process, in which the full message is obtained from the message repository 124 and sent to the ones of the recipient services 118a-d that indicated an availability to perform the requested functionality (and/or that were selected to do so by the orchestration engine 120). Also, rejected ones of the recipient services 118a-d (e.g., which perhaps either did not reply during the first phase, or which replied to inform the sender service 110 of being unavailable to perform the desired functionality) may be notified of their rejected status by the orchestration engine 120.

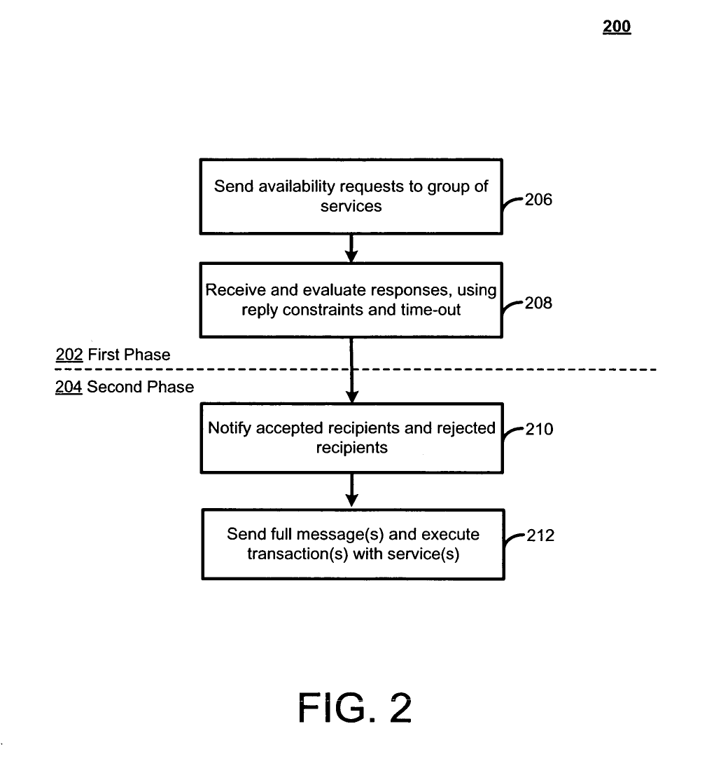

FIG. 2 is a flowchart 200 illustrating an operation of the system of FIG. 1. As described above, the operation includes a first phase 202 and a second phase 204. In the first phase 202, availability requests are sent to a group of recipients (202). For example, the service 110, using the messaging infrastructure 112, may send such availability requests to the services 118a-118d. The availability requests may be configured as described herein, e.g., with sufficient information to allow the recipients to determine their respective availability, with transactional support (e.g., identifier(s) and date/time stamp), and with reply constraints and a time-out period that will be used to govern the execution and completion of the first phase 202.

Responses are received and evaluated during a remainder of the first phase 202, based on the reply constraints and time-out period (208), as well as on a remainder of the information contained in, or associated with, the responses. For example, receipt of the responses may be logged in the message log 128 (and the response messages themselves persisted to the message repository 124), until at least a minimum, but no more than a maximum, number of responses have been received (and/or until the time-out period has been reached). In a related implementation, described in more detail below, when a number of responses are received that exceed the maximum number set in the reply constraint, then the responses may be prioritized and only the prioritized responses, up to the maximum number, may be kept and used.

Then, in the beginning of the second phase 204, available recipients which have been accepted are notified of the acceptance, while rejected recipients (e.g., recipients which indicated no availability, or which were not selected, and/or which did not answer at all during the first phase 202) are also notified of their status as such (210). For example, in FIG. 1, a scenario may occur in which the reply constraints include a minimum of two and a maximum of three. Then, the services 118a-118d receive availability requests, and the services 118a-118c reply with an availability indication, while the service 118d either does not reply or replies with a rejection of the availability request. Then, the messaging infrastructure 112 may determine that the minimum and maximum constraints have been met (presumably before a time-out occurs), and the recipients 118a-118d may be notified appropriately during the second phase 204 as to their status.

Then, the full message(s) may be sent during executions of transactions with the (accepted and approved) recipient services (212). For example, continuing the example above, a service request may be sent to each of the recipients 118a-118c, authorizing each of those recipients to proceed with whatever transaction is to be conducted. In this way, appropriate recipients may be found to conduct such transactions in a fast, reliable way, without having to wait for a response from all members of the group 114.

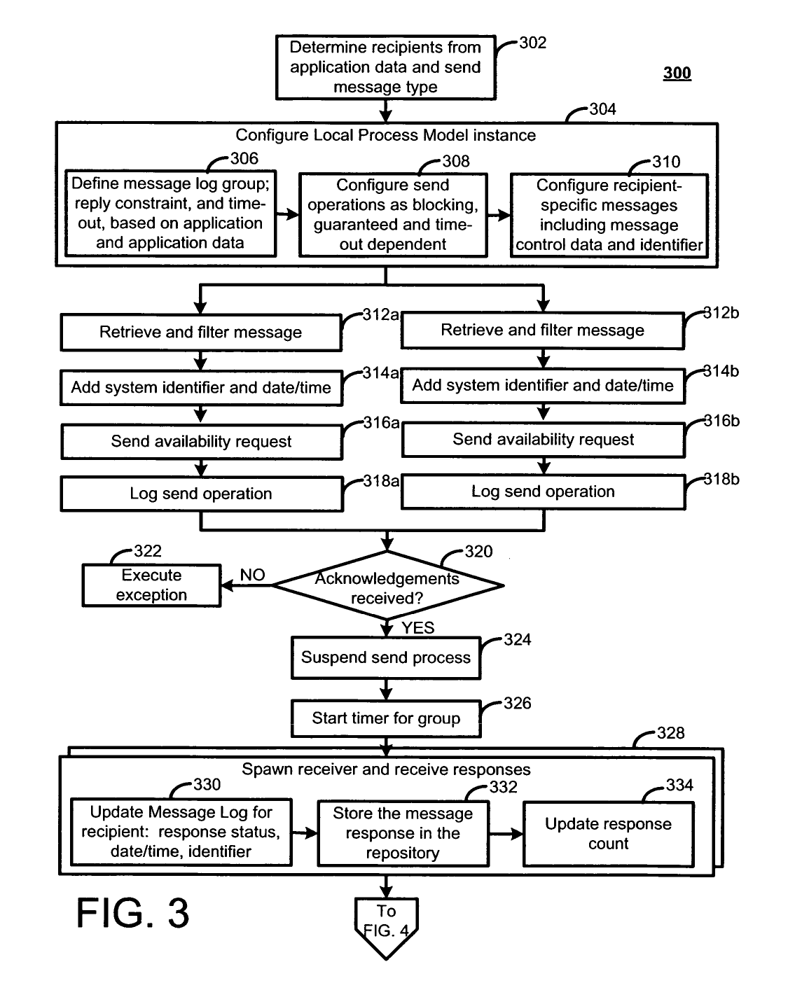

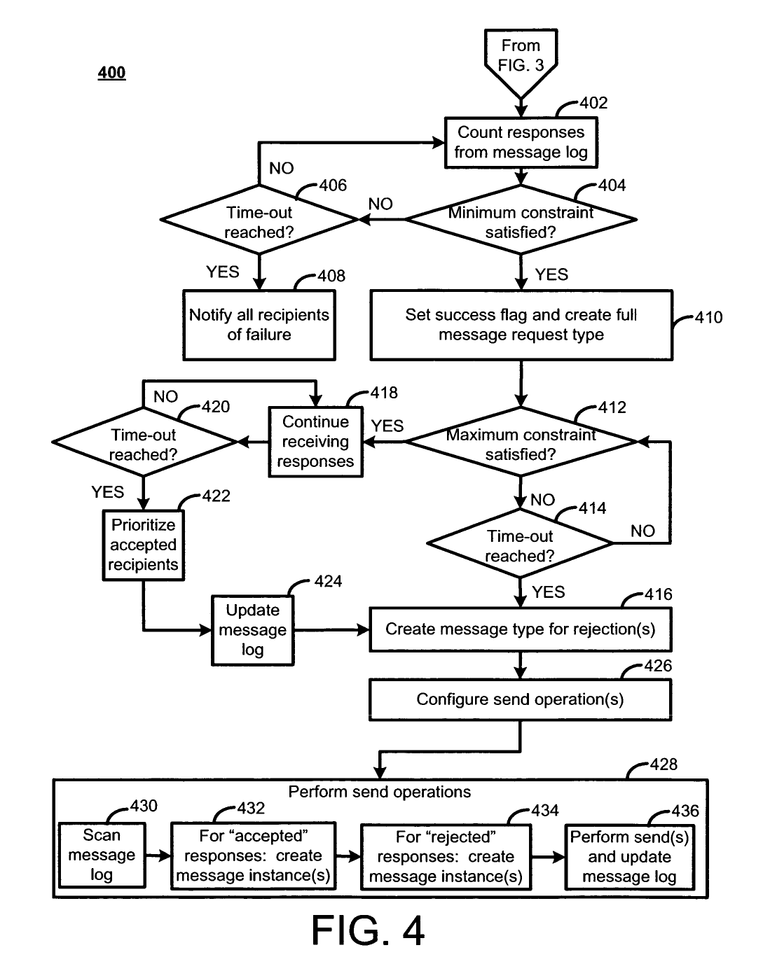

FIGS. 3 and 4 provide more detailed examples of implementations of the operation 200 of FIG. 2. For example, FIG. 3 is a flowchart 300 illustrating detailed examples of a first set of operations associated with the operation 200 of FIG. 2, while FIG. 4 is a flowchart 400 illustrating detailed examples of a second set of operations associated with the operation 200 of FIG. 2. It will be appreciated that FIGS. 3 and 4 may represent a continuous operation, that is represented in multiple figures merely due to space limitations.

In the example of FIG. 3, then, the operation may start by determining recipients based on application data and a send message type (302), e.g., from or for the business application 106. The send message type and recipients may be stored, e.g., in the message repository 124. For example, a user may enter application data, using a user interface, such as a group of recipients 118a-118d involved in securing travel reservations, e.g., travel reservation services such as flight reservation services, hotel or rental car reservation services, and other such services. The fact that travel reservation services (and associated send message types such as reservation requests) are at issue also may convey information regarding the recipients, such as identifying a pool of possible recipients.

As already described, an order of message exchanges between the interacting sender service 110 and the recipient services 118a-118d, as well as certain other rules governing the message exchanges, may be provided at design time and governed by the global process model 102. However, application data such as the examples just provided may vary at run-time, since a user may select a desired type of services, and may specify to one extent or another various ones of whatever services may be available.

Accordingly, the local process model may be configured (304) to account for such run-time variation. For example, a message log group may be defined, along with relevant reply constraint(s) (e.g., minimum and maximum recipients that are required/allowed to respond) and a time-out period for collecting responses from the message log group of recipients (306). For example, the message log group 114 may be defined to include the services 118a-118d, and a minimum and maximum number of replies may be set, for example, at two and four. The time-out period (along with the group 114 itself and the reply constraints) may be set based at least partly on the application data, and/or may be selected by the user. The message log group, reply constraints, and time-out information all may be stored in the message log 128.

The send operations to follow may then be preemptively configured as blocking, guaranteed, and dependent on a time-out (308). A blocking configuration implies that the sender, e.g., service 110, blocks any additional sending while waiting on responses to the availability requests (so that the responses may be evaluated in the meantime). A guaranteed send operation implies that the sender, e.g., the service 110, expects an acknowledgement for each send operation that does occur. Finally, as is apparent, a time-out dependency configuration simply implies that the sending process is, in fact, subject to a time-out period.

Then, a message may be configured for each recipient, including message control data and an identifier associated with the instance of the local process model being configured (310), so that information for a transactional exchange is available and configured. For example, the message formatting system 130 may configure the “full” message described above, including information for the first phase (acceptance/rejection) and for the second phase (notification/execution). The transaction resource engine 122 may be used to generate the identifier, which may be used to correlate message sent/received by the messaging infrastructure 112. The transaction resource engine 122 also may generate a time stamp that may be used, for example, to evaluate the time-out condition. The message also may contain sender information and application-specific data (e.g., types of travel reservations requested, maximum price to be paid, name of user requesting travel reservations, or any other application data that may be specific to the business application 106). The message may be split into a first part associated with the first phase, and a second part associated with the second phase. All such messages may be stored in the message repository 124.

Having performed the various configurations just described, a first phase of the interaction may begin. For example, for each recipient substantially in parallel (where FIG. 3 illustrates two recipients in parallel, where of course the illustrated operations may be executed for virtually any number of recipients, as would be apparent), the following operations may be implemented.

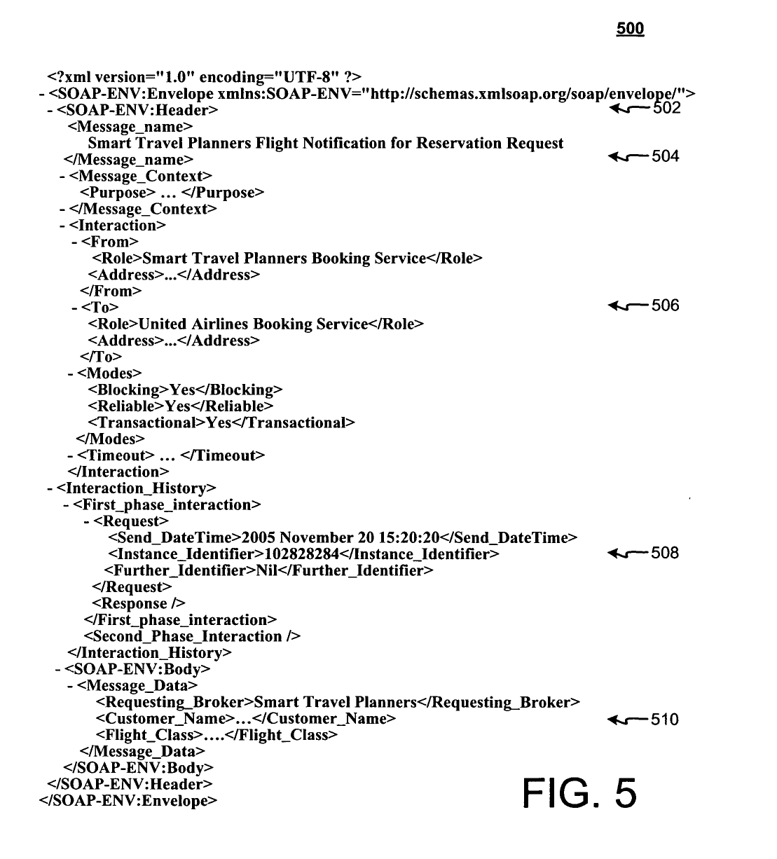

A message intended for a recipient may be retrieved from the message repository 124 and filtered to remove a portion of the message that includes information regarding the second phase (312a, 312b). For example, where the message is written using the Mark-up Language (XML), an XQUERY expression may be used to query the message repository 124 and obtain the desired portion of a given message(s). An example of a resulting message is provided below with respect to FIG. 5.

Then, a system identifier and date/time stamp may be provided (314a, 314b), e.g., by the transaction resource engine 122. It should be understood that the system identifier referenced here should be different from the identifier already discussed, since it may be necessary to identify both the overall instance of the local process model 108 being executed, as well as each recipient responding/interacting as part of that execution.

Then, an availability request is sent (316a, 316b). For example, the orchestration engine 120 may send, via the message handler 126, an availability request to each of the services 118a-118d. As already described, such an availability request is designed as part of the first phase of the interaction(s) merely to determine whether any of the recipient service(s) are available, willing, and able to execute the desired transaction. Sending of the availability request(s) in this manner may be logged in the message log 128 (318a, 318b), including the date/time stamp.

In the example of FIG. 3, an acknowledgment to the availability request(s) is expected to be received (320). Such an acknowledgement merely refers to a notification by each recipient that the availability request has been received, and does not generally signify any substantive decision or indication by any of the recipients regarding an availability to provide the requested service interaction. Accordingly, these acknowledgments are expected fairly quickly, subject only, for example, to various network latencies or other delays or malfunctions that may occur. A separate time-out may be set for these acknowledgments, or it may be the case that acknowledgements are expected so quickly that a separate time-out would not be particularly beneficial.

If one ore more acknowledgements are not received, then an exception may be generated (322). For example, a design of the local process model 108 may specify how such exceptions may be handled, e.g., by the orchestration engine 120. For example, the process may be aborted or re-started.

If acknowledgements are received, then the send process may be suspended (324). For example, since the send operations already have been configured as blocking, as described above, such suspension may occur automatically, as the orchestration engine 120 executes the instance of the local process model 108.

Then, a timer may be started for the group (326), against which the time-out condition may be evaluated. In this example, it is assumed that there may be some time difference that occurs between the different processes 312a-318a and 312b-318b (and/or analogous recipient-specific processes). Accordingly, by starting the timer associated with the message log group once all such processes are completed and acknowledgements are received, it may be ensured that the entire group 114 is subject to the same time-out conditions. Nonetheless, in other implementations, the timer may be started at a different point, e.g., before the processes 312a-318a/312b-318b are begun.

With the timer running, a receiver may be spawned for each recipient (i.e., for each of the processes 312a-318a/312b-318b), and may wait to collect a response to the availability request from its associated recipient (328). For example, the orchestration engine 120 may spawn a receiver(s) in association with the message handler 126. The receiver(s) receive the responses as indicating “yes” or “no” to the availability requests to indicate a corresponding availability (or lack thereof). Accordingly, the responses should be understood to be, in the described implementation, a business (i.e., application) level response, as opposed to the communications system acknowledgement already received above.

In receiving the responses while the timer is running, the following operations may be performed in parallel for each recipient/receiver. For example, the message log 128 may be updated for the recipient to indicate a current response status (e.g., accepted or rejected), a date/time of the message response, and an identifier for the message response (330). In indicating a current response status, a differentiation may be made between recipients that indicate rejection (or recipients rejected because a maximum constraint has already been met) and recipients that failed to respond to the availability requests at all, where the latter category of recipients may be marked as “ignored” rather than rejected.

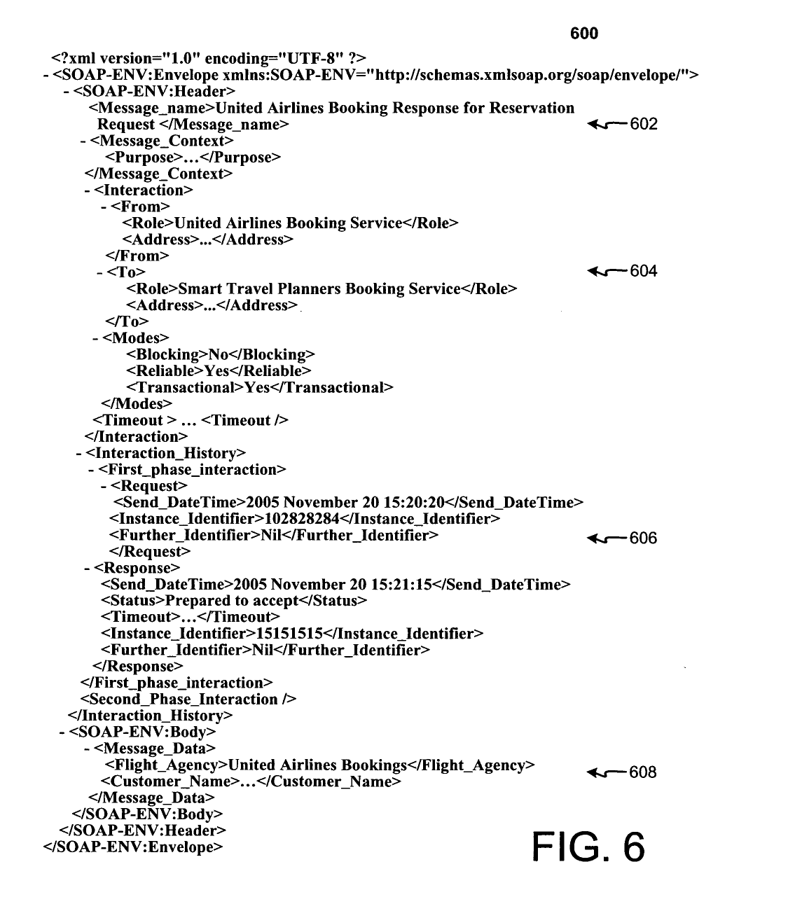

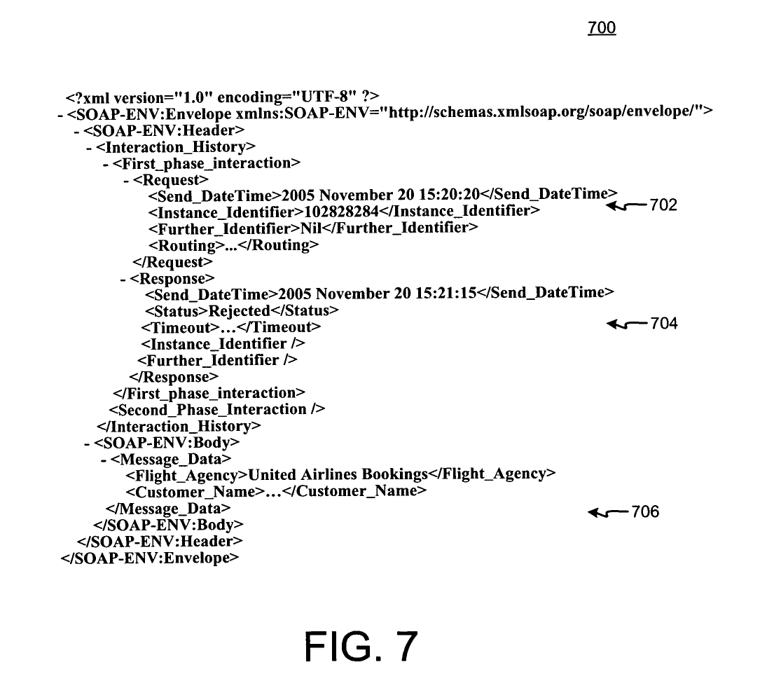

The response to the availability request may then be stored in the message repository 124 (332). A response count may then be updated (334) to reflect a current number of responses received from all recipients. As described in more detail below, it should be understood that collection of responses may proceed as long as the time-out period has not been reached. An example of an accepting response message is provided below with respect to FIG. 6, and an example of a rejecting response message is provided below with respect to FIG. 7.

Continuing into FIG. 4, evaluation of the first phase of interactions continues with a counting of the accepting responses from the message log 128 (402). For example, as should be apparent from the above description, each receiver is responsible for tracking its own response(s) and updating the message log 128 accordingly. In this way, the message log 128 may be provided as a central location against which response count totals may be obtained and evaluated.

As the counting continues, a determination is made as to whether the minimum constraint of the reply constraint has been satisfied (404). If not, and if the time-out has not been reached (406), then the counting may continue (402). If the time-out has been reached without the minimum constraint having been satisfied in terms of total number of responses received, then all recipients may be notified of a failure of the interaction (408).

Advantageously, it should be understood that, at this point, none of the recipients 118a-118d will have begun executing the requested service(s). This may be understood from the fact that the availability requests are filtered from the full messages, such that information necessary to allow the recipients 118a-118d to begin executing their respective services is not provided. Accordingly, there is no need to “roll-back” or compensate for any such unnecessary executions.

If the minimum constraint is satisfied (404), then a success flag for the first phase may be set, and a full message type may be configured, e.g., based on (and/or filtered from) the full message (410). For example, it may be the case that the recipients 118a and 118b have sent “available” responses, so that, if a minimum constraint is equal to “two,” the success flag may be set. At this point, it may be assumed that the transaction/interaction will move forward; however, it may not be assumed that both of the recipients 118a and 118b will be included therein. For example, in a case where low prices/bids are being solicited, it may be the case that the recipient 118c will ultimately provide the lowest price/bid, so that the recipient 118c may be included in addition to, or in the alternative to, one or both of the recipients 118a and 118b.

Therefore, in one implementation, the created full message request type may be pre-configured to a certain extent, in anticipation of the future success of the operation. For example, the full message request type may be configured only generically with respect to the recipients 118a-118d, and/or may be configured so that any later changes thereto (based on selection of an alternative service recipient) will be minimal. In other implementations, the full message request type may not be created until all constraints have been satisfied, the time-out condition has occurred, and/or all of the recipients participating in phase two have been definitively identified.

Counting of the accepting responses may continue, and a determination is made as to whether a maximum constraint has been satisfied (412). If not, and if the time-out condition has not been satisfied (414), then counting continues. If the time-out condition has been reached, and considering that in this example operation the maximum constraint has not been reached, it may be assumed that at least one recipient will be rejected (or ignored), so that a corresponding full message type may be created (416). Again, such a message type may be created based on, and/or filtered from, the full message created and stored in the message repository 124.

If the maximum constraint is satisfied (412), then responses may continue to be received (418) as long as the time-out condition has not been met (420). Once the time-out condition is reached, however, then it may be necessary or desirable to prioritize the accepted (accepting) recipients (422). For example, it may be the case in FIG. 1 that a minimum of two and a maximum of three recipients are defined. However (and contrary to at least one example mentioned above), it may be the case that all four of the recipients 118a-118d accept the availability request(s) from the messaging infrastructure 112 within the relevant time-out period.

In this case, and assuming for simplicity's sake that the recipients responded in time order from 118a-118d, it may be seen that the maximum constraint (“three”) is reached when the recipient 118c responds affirmatively (412). However, as described, responses may continue to be received and evaluated even after the maximum constraint is satisfied, so that it may occur that the recipient 118d responds affirmatively before the time-out is reached. In this case, it may occur that the recipient 118d is, in fact, superior in some aspect to at least one of the previously-accepting recipients 118a-118d. A priority function may be called to make such a determination, based, for example, on a quantitative evaluation of a merit (e.g., price or bid) of each recipient, or on some more qualitative evaluation (e.g., user preference). Once such prioritization has occurred, the message log may be updated (424) to reflect any change between a previously-accepted recipient and a newly-accepted recipient that is judged by the priority function to be superior.

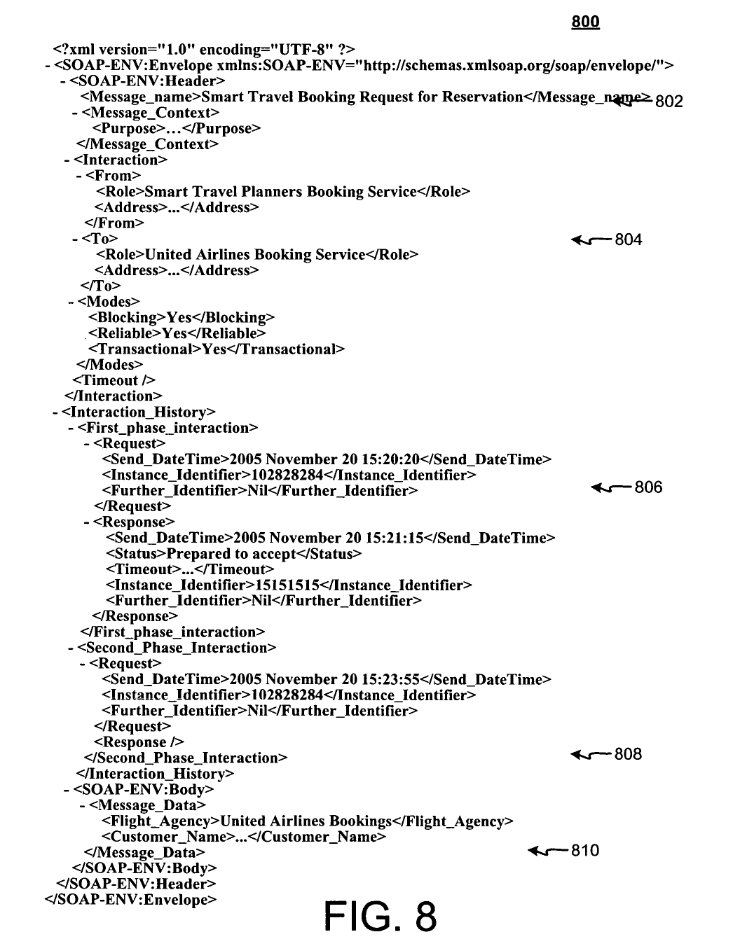

Then, the send operations to follow in the second phase may be configured (426). For example, the send operations may be configured and/or parameterized to be blocking and guaranteed, as described above with respect to the phase one message(s). Send operations may then be performed (428). In the example of FIG. 4, the message log is scanned (430) to determine recipients. For accepted recipients, a specific message instance may be created (432), e.g., based on the accepting message type created above. An example of such an accepting message instance is provided below with respect to FIG. 8. As part of this operation(s), the message may be created/updated with information related to the second phase of interactions, e.g., an appropriate identifier and date/time stamp that may be included in the message control data. The thus-formed messages may then be stored in the message repository 124.

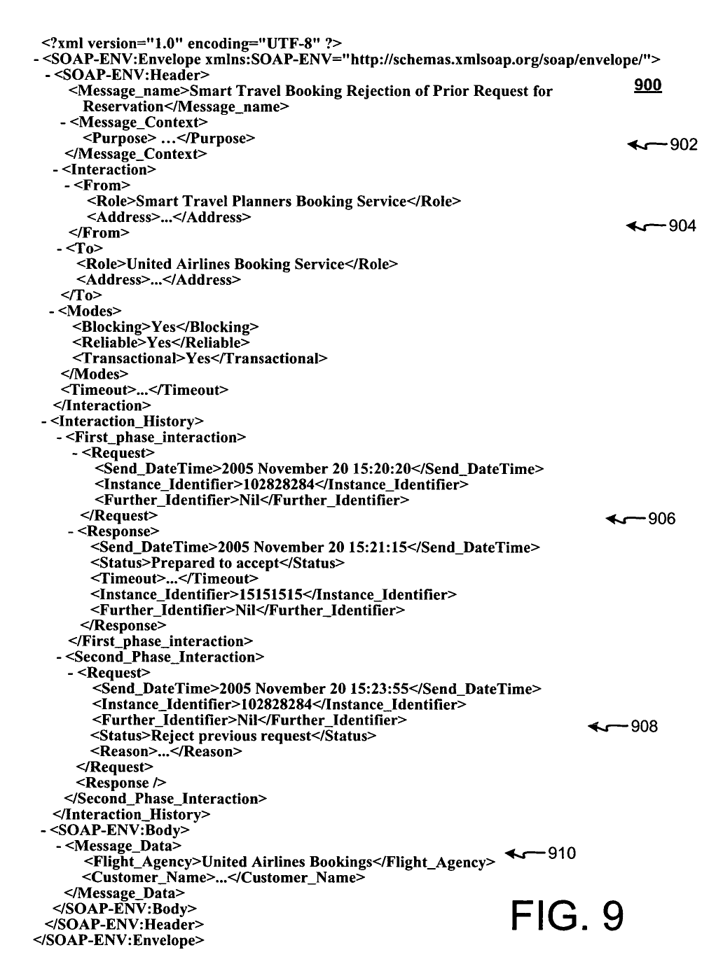

For rejected (or ignored) recipients, similarly, a specific message instance may be created (434). An example of such an accepting message instance is provided below with respect to FIG. 9. Again, the earlier-created message type may be used, along with updates such as, again, an appropriate identifier and date/time stamp in the message control data. The thus-formed messages also may then be stored in the message repository 124.

Finally in FIG. 4, the actual send operation(s) may be performed, and the message log updated accordingly (436). In this way, the selected ones of the recipients 118a-118d may be allowed to proceed with providing their respective, requested services.

FIGS. 5-9 illustrate examples messages that may be used in the examples of FIGS. 1-4. In these examples, it is assumed that a requesting or sending service (referred to as “Smart Travel Planners” and representing, for example, the sender service 110 of FIG. 1) is initiating an atomic multicast transaction with the group 114 that includes a recipient service agency (referred to as “United Airlines Bookings” and representing, for example, the recipient service 118a of FIG. 1) for reserving a flight.

In FIG. 5, as mentioned above, a message 500 is illustrated that represents a filtered, first-phase availability request, such as discussed above with respect to FIG. 3 (e.g., 312a-316a). As may be seen, the message 500 is an XML message that is compliant with the Simple Object Access Protocol (SOAP) protocol, a well-known protocol for invoking applications using XML over hyper-text transfer protocol (HTTP).

Accordingly, a section 502 specifies an XML version being used, and includes an opening of a SOAP envelope that itself contains an opening of a SOAP header (as well as a SOAP body, discussed in more detail below). A section 504 includes name, purpose, and context information for the message. For example, a message name, “Smart Travel Planners Flight Notification for Reservation Request” may be included.

A message purpose may be included in the section 504, as well. For example, a statement of purpose may be included that indicates that the message purpose is to request a flight reservation under a particular Act/Statute/Code/Rule, and/or subject to a contractual agreement between the United Airlines Bookings recipient and the Smart Travel Planners sender. The purpose may specify that, as already explained, the purpose of the message 500 is to confirm that a flight reservation may be made, according to whatever business protocols have been agreed to by both parties.

A section 506 includes message control data for conducting one or both phases of the interaction. For example, the section 506 specifies that the message 500 is from the Smart Travel Planners Booking Service, along with an address thereof and/or other related information. Similarly, the section 506 specifies that the United Airlines Booking Service is the intended recipient of the message 500. Further, the section 506 illustrates examples of the configured send modes discussed above (e.g., 308 and/or blocking, guaranteed, transactional, reliable). Timeout information also may be included in the section 506, for, as described, maintaining an amount of time in which responses will be accepted for consideration.

In a section 508, an interaction history including a first phase of interaction(s) is provided. Specifically, a date/time stamp is included, along with an instance identifier “102828284” (e.g., 310 of FIG. 3). It should be noticed that information related to the second phase of the interaction is not included in the message 500, since such information was specifically filtered and removed, as described above. Other information, such as routing information and/or an additional identifier, also may be included.

A section 510 includes a SOAP body that includes actual message data. For example, message data includes a name of the requesting (sender) broker service, a name of the customer in question, and perhaps other information, such as a flight class preference of the user.

FIG. 6 is an example of a message that might be sent in response to the availability request, as discussed, for example, with respect to FIG. 3 (328-334). Many aspects of the message 600 may be seen to be similar or the same with regard to form and/or function as the message 500 of FIG. 5. For example, a section 602 includes a message name, “United Airlines Booking Response for Reservation,” as well as a message purpose that may be similar in concept to the purpose field of the message 500, but that here may specify that the purpose of the message 600 is to respond to the earlier availability request, and to indicate acceptance of the message 500 and a confirmation that the requested flight reservation may be made, if so instructed, and according to the relevant business protocols.

A section 604 includes interaction information including a specification of the “from” and “to” parties, as well as their respective addresses. As in FIG. 5, configuration information and a time-out are specified in the section 604 of FIG. 6, as well.

A section 606 indicates a now-updated interaction history, which includes information discussed above along with new response information provided by the recipient (Smart Travel Broker Service). The response information includes a date/time stamp, an identifier (15151515) provided by the recipient service, and any other information (e.g., routing information) that may be permitted and included. As above, no substantive information regarding the second phase of the interactions is included, other than a placeholder for the second phase interaction that is to follow.

Finally, a section 608 includes message data, including, e.g., a name of the sender service and a name of the customer in question who is using the business application 106 (and the sender United Airlines Booking Service). In some implementations, the message data may be used to provide a required identifier, since, for example, a flight number plus a customer name may be used as such. Then, the transaction resource engine 122 may be used to support the transactional nature of the described interactions, based on the identified message data.

FIG. 7, on the other hand, is an example message 700 in which an availability request in a first phase of the two-phase interaction is rejected by the recipient service (here, the Smart Travel Planners Booking Service). Accordingly, a section 702 identifies the (availability) request in question. A section 704 provides information about a response of the recipient, including a status of the response/recipient as “rejected.” A section 706 includes the message data previously provided as part of the message 500.

FIG. 8 is an example message 800 that represents a full message (see FIG. 4, e.g., 432) in which the original sender (United Airlines Booking Service) creates a message for responding to the recipient (Smart Travel Planner Service) with a full, unfiltered message. Thus, the message 800 includes a section 802 that is similar to the section 504 of FIG. 5, but that may include, for example, a different purpose statement. A section 804 includes information similar to the section 506 of FIG. 5, as described above.

A section 806 includes an interaction history that now includes information about the first phase of the interaction, including both the original request and the resulting, received response (in which the recipient indicates a status of “prepared to accept”). A section 808 includes control data for the second phase of the interaction, and a section 810 includes the message data, which the recipient service will be allowed to process to, in this example, provide the desired flight reservation.

FIG. 9 is an example message 900 in which the original sender (United Airlines Booking Service) responds to the recipient (Smart Travel Planner Service) to alert the recipient of its status as rejected (e.g., FIG. 4, 434, where, for example, the recipient may have been pushed out by an action of the priority function, perhaps in favor of another recipient that indicated an “available to accept” status). Thus, the message 900 also includes a section 902 that is similar to the section 504 of FIG. 5 and the section 804 of FIG. 8, but that may include, for example, a different purpose statement that reflects the rejection of the current recipient. A section 904 includes information similar to the section 506 of FIG. 5 and the section 806 of FIG. 8, as described above.

A section 906 includes an interaction history that now includes information about the first phase of the interaction, including both the original request and the resulting, received response. A section 908 now includes information about a second phase of the interaction, including, for example, a notification of status in which it is indicated that the current status is “reject previous request.” Finally in FIG. 9, a section 910 includes the message data (content), as described above.

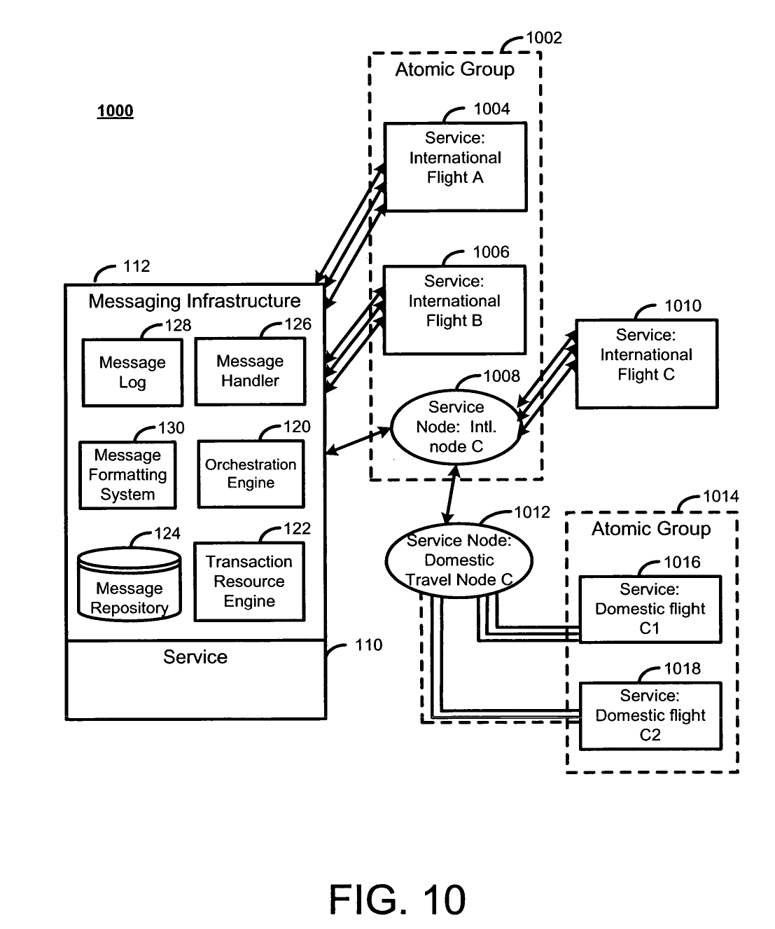

FIG. 10 is a block diagram of a system 1000 that provides another example implementation of the system of FIG. 1. In the example of FIG. 10, atomic transactional multicasting is carried out with respect to nested groups of recipients. For example, the service 110 may be a travel planning service, along the lines of the examples above, and may be attempting to coordinate an international flight plan for a user. As such, it may be the case that a number of international flights must be scheduled, while it also may occur that a domestic or local flight should be scheduled at a given one of the international locations. For example, a flight plan may be made for a traveler who intends to fly from Germany to Australia to South Africa and then back to Germany. One or more domestic flights may be scheduled, for example, during the time spent in Australia. It should be understood, then, that the international flight plan(s) may all be required to be made, since otherwise the traveler would not have arrangements to return home. On the other hand, the domestic flight plans may or may not be required, since the traveler could theoretically not schedule a given domestic flight plan and still not be disadvantaged with respect to the overall international flight plans.

Along these lines, FIG. 10 illustrates a first atomic group 1002 that includes a first service 1004 (for International Flight “A”) and a second service 1006 (for International Flight “B”). The group 1002 also includes a service node 1008 (for International node “C”), which is associated with a service 1010 (for International Flight “C”) and a further service node 1012 (for domestic travel node “C”), where the latter node 1012 is associated with a nested atomic group 1014 that includes a service 1016 (for a domestic flight “C1”) and a service 1018 (for a domestic flight “C2”).

Thus, as referenced above, the first atomic group 1002 may be associated with a first reply constraint that requires that all member services participate in the service interaction(s) (i.e., in the flight planning). However, a different reply constraint may be applied to the second atomic group 1014, since, for example, it may be the case that only one of the two services 1016, 1018 may be required to participate in the interaction(s), since, for example, one of the domestic flights may be missed as long as the associated service 1010 for the international flight “C” participates.

By allowing the nesting structures as described, and by allowing different reply constraints (e.g., different minimum and maximum constraints for the group 1002 and the group 1014), a degree of flexibility, convenience, and scalability may be added to the system 100 of FIG. 1. For example , the service 110 may be allowed to execute a single, comprehensive flight plan, including additional services related to car rentals, hotel accommodations, and other travel-related services, while taking into account a number of different requirements or expectations related to the various services. In such scenarios, as described, failure of one service within a given (nested) group (e.g., failure of the service 1018 within the group 1014) need not necessarily cause a failure of the overall flight plan, even where an “all-or-nothing” condition may be applied to a higher-level group (e.g., to the international flight plans of the highest-level group 1002).

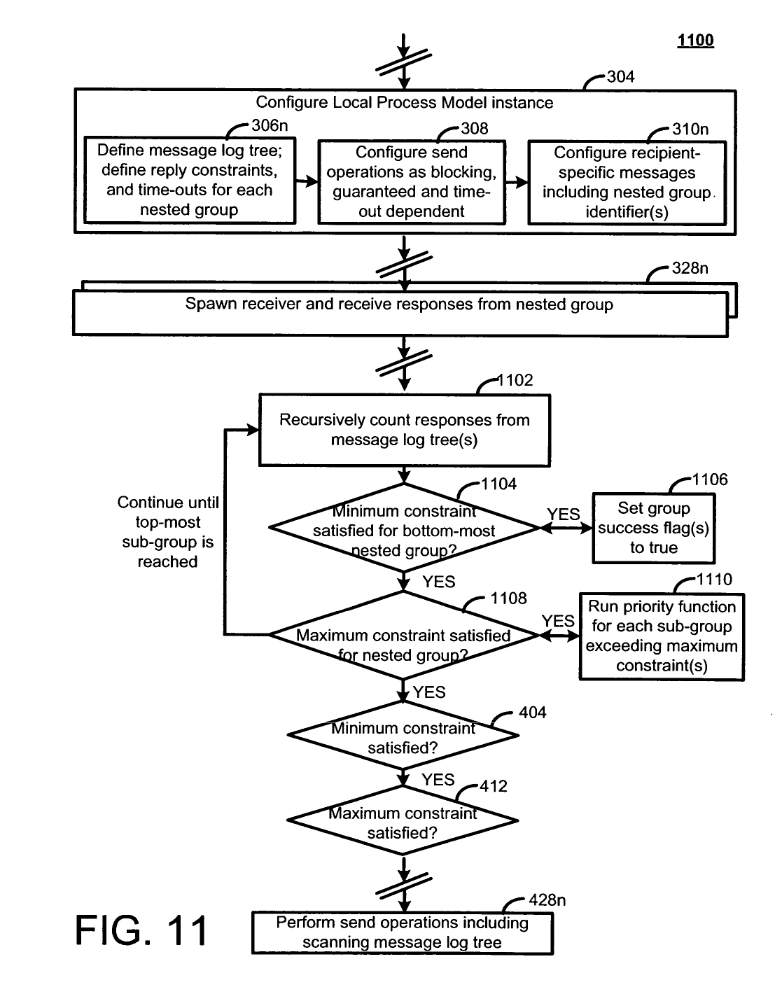

FIG. 11 is a flowchart 1100 illustrating an operation of the system 1000 of FIG. 10. It should be understood that the operation of the system 1000 may occur in much the same manner as described above with respect to FIGS. 1-9. That is, the system 1000 may execute a two-phase commit process using the messaging infrastructure 112, in which the availability requests are sent out during the first phase, responses to which are judged against one or more reply constraints and a time-out period, where the latter parameters may be defined on a group-by-group basis. Then, the system 1000 may execute the second phase to proceed in the interactions with the selected services.

Accordingly, the flowchart 1100 is primarily intended to illustrate differences between the system 100 and the system 1000 that may occur as a result of the fact that nested group(s) is/are included in the system 1000. As such, the flowchart 1100 reproduces in concept the flowcharts 300 and 400 of FIGS. 3 and 4, respectively, with certain operations omitted for the sake of clarity. Similarly, certain operations may be abbreviated. However, it should be understood that any and all of the operations of FIGS. 2-4 may be included in implementations of the system 1000 and/or in the operations of the flowchart 1100. With regard to notation, it will be appreciated that operations of the flowchart 1100 that are modified from corresponding operations in FIGS. 3 and/or 4 may be written with a suffix “n,” including 306n, 310n, 328n, and 428n.

Thus, in FIG. 11, a local process model is configured (304). A message log tree of groups is defined (306n), where each node of the group(s) is either a recipient or group, and where the tree mirrors the nesting of the groups. A minimum and maximum constraint, and a time-out period, may be defined for each of the groups, and the message log tree may then be stored in the message log 128. Send operations are configured as blocking, guaranteed, and time-out dependent (308). Then, recipient-specific messages may be configured, including a separate identifier for each nested group (310n). The separate identifier for the nested group allows, for example, correlation of responses received from recipient members of the nested group.

After following similar operations of FIG. 3 not shown in FIG. 11 (e.g., 312a/312b-326), receivers are spawned to receive messages from the various recipients, including the recipient members of any nested group(s) (328). That is, responses may be collected in parallel for each group, while a timer associated with each group continues to run. A timer for the first or primary group (e.g., the group 1002 in FIG. 10) will generally govern the timers of the nested group(s), in the sense that a time-out of the group 1002 may automatically cause an end of response-collection from any nested groups.

Evaluation of the received responses may proceed with a recursive counting of responses from the message log tree configured earlier (1102). For example, a determination may be made as to whether a minimum constraint has been met for a first nested group (1104), and, if so, then a success flag for that nested group may be set to true (1106). Similarly, a determination may be made as to whether a maximum constraint has been satisfied for the nested group (1108). If so, and if a number of responding recipients in fact exceeds the maximum constraint, then a priority function may be called to select preferred recipients from the responding recipients (1110), as described above with respect to FIG. 4.

The structure of the message log as including tree structures to represent the nested groups, and the nature of the nested groups themselves, implies the use of recursive counting, as shown in FIG. 11. That is, a counting of the tree structure may be performed by following the tree structure from the top-most (primary) group down to the bottom-most nested group. Then, actual evaluation of reply constraints may be performed starting from the bottom-most group and moving back up toward the top-most group.

Then, a similar process may be applied for the transaction as a whole, e.g., reply constraints for the top-most group may be evaluated (404, 412). It should be understood that such evaluations may be considered to be included in the recursive processing described above, but are shown separately in FIG. 11 to emphasize their nature as applying to the top-most or final group (and for consistency with FIG. 4).

Finally in FIG. 11, send operations may be performed by scanning the message log tree (428n) and sending appropriate messages to accepted and rejected recipients. The message log tree may then be updated appropriately.

As described above, atomic transactional multicasting may be carried out without requiring an “all or nothing” participation of members of the atomic group of recipients. Instead, a minimum and/or maximum number of the group may be sufficient to proceed with the transaction, and a time-out may be used to avoid undue delays and non-responsive recipients. Further, by using the two-phase commit process as described herein, compensation or “roll-back” of (partially) executed tasks of a process model may be avoided, since such tasks may not proceed unless and until the second phase of the process is reached.

Further, terminology used herein should be broadly interpreted. For example, although the application 106 is discussed as a business application, it should be understood that in these contexts the term “business application” may refer to any application that is used in profit generation of some sort, although the business application 106 also may refer to non-profit endeavors as well, including the legal system example above, but also including schools, churches, charities, hospitals, or virtually any other organization. Further, the business application 106 is merely an example, and other applications, such as applications for personal use, also may be used

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program described above, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Methods may be performed by one or more programmable processors executing a computer program to perform functions by operating on input data and generating output. Methods also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Thus, while certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
sending availability requests to a group of recipients according to an instance of a process model to determine available recipients for implementing a transaction of the process model, based on responses to the availability requests;
evaluating the responses to determine satisfaction of a reply constraint governing a required number of the available recipients; and
sending a service request to accepted recipients of the available recipients, to implement the transaction.

2. The method of claim 1 wherein sending availability requests to a group of recipients comprises:
defining the reply constraint to include a minimum number of the available recipients required to proceed with the sending the service request.

3. The method of claim 1 wherein sending availability requests to a group of recipients comprises:
defining the reply constraint to include a maximum number of the available recipients allowed to proceed with the sending the service request.

4. The method of claim 1 wherein sending availability requests to a group of recipients comprises:
defining a time-out period associated with the group of recipients, the time-out period defining a period beyond which responses from the recipients will not be accepted.

5. The method of claim 1 wherein sending availability requests to a group of recipients comprises:
sending the availability requests with insufficient information for the recipients to implement the transaction.

6. The method of claim 1 wherein sending availability requests to a group of recipients comprises:
determining the service request as including a recipient-specific message to be sent to each of the recipients; and
filtering the recipient-specific messages to obtain the availability requests, including recipient-specific availability requests.

7. The method of claim 1 wherein sending availability requests to a group of recipients comprises:
associating transactional information with the availability requests, the transaction information including an identifier associated with the instance of the process model.

8. The method of claim 1 wherein sending availability requests to a group of recipients comprises:
sending first availability requests to a first group of the group of recipients, the first group being associated with a first required minimum number of responses indicating availability to implement the transaction, and the first group including a service node associated with a second group of the group of recipients; and
sending second availability requests to the second group, the second group being associated with a second required minimum number of responses indicating availability to implement the transaction.

9. The method of claim 1 wherein evaluating the responses to determine satisfaction of a reply constraint comprises:
evaluating the responses to determine the available recipients and to determine rejected recipients of the group of recipients, where the rejected recipients are unavailable or unable to implement the transaction.

10. The method of claim 1 wherein evaluating the responses to determine satisfaction of a reply constraint comprises:
associating the responses with the instance of the process model and with a responding recipient, based on at least one identifier.

11. The method of claim 1 wherein evaluating the responses to determine satisfaction of a reply constraint comprises:
counting the available recipients to determine that a minimum number of available recipients have been determined for possible inclusion in the accepted recipients.

12. The method of claim 1 wherein evaluating the responses to determine satisfaction of a reply constraint comprises:
counting the available recipients to determine that a maximum number of available recipients have been determined.

13. The method of claim 12 wherein counting the available recipients to determine that a maximum number of available recipients have been determined comprises:
determining that a greater-than-maximum number of recipients has been determined;
prioritizing the greater-than-maximum number of recipients with respect to implementing the transaction, to obtain prioritized recipients; and
selecting the maximum number of available recipients from the prioritized recipients to obtain the accepted recipients.

14. The method of claim 1 wherein sending a service request to accepted recipients of the available recipients comprises:
sending recipient-specific service requests as including the availability requests supplemented with message data associated with implementing the transaction.

15. A system comprising:
a message formatting system that is operable to format availability requests for a group of recipients associated with an instance of a process model; and
an orchestration engine that is operable to execute the process model including being operable to send the availability requests to the recipients, and being operable to evaluate responses received from the recipients within a defined time-out period to determine available recipients for implementing a transaction of the process model.

16. The system of claim 15 wherein the orchestration engine is operable to send a service request to accepted recipients of the available recipients, and further operable to implement the transaction in conjunction with the accepted recipients.

17. The system of claim 16 wherein the orchestration engine is operable to determine a maximum number of the accepted recipients, based on the responses and/or on a priority function used to prioritize the available recipients.

18. The system of claim 15 comprising:
a message log that is operable to log the responses received from the recipients, for counting thereof by the orchestration engine to determine that at least a minimum number of available recipients have been determined.

19. The system of claim 15 comprising:
a transaction resource engine that is operable to provide identifiers to be read by the orchestration engine for associating the responses with at least one of the instance of the process model, the transaction, and/or a responding recipient.

20. A computer program product comprising:
a signal-bearing medium bearing at least one of
one or more instructions for providing availability requests for a group of recipients associated with an instance of a process model;
one or more instructions for evaluating responses received from the recipients to determine available recipients for implementing a transaction of the process model, based on a reply constraint specifying a minimum number of available recipients required to complete a transaction associated with the process model; and
one or more instructions for sending a service request to accepted recipients of the available recipients, for execution thereby of the transaction.
